(19) United States
(12) Patent Application Publication
(10) Pub. No.: US 2006/0100867 A1
(43) Pub. Date: May 11, 2006

(54) Method and apparatus to eliminate noise from multi-channel audio signals

(76) Inventors: Hyuck-jae Lee, Seoul (KR); Seoung-hun Kim, Suwon-si (KR); Jae-ha Park, Yongin-si (KR); Yoon-hark Oh, Suwon-si (KR)

Correspondence Address: STANZIONE & KIM, LLP, 919 18TH STREET, N.W., SUITE 440, WASHINGTON, DC, 20006, US

(21) Appl. No.: 11/132,309

(22) Filed: May 19, 2005

(30) Foreign Application Priority Data
Oct. 26, 2004 (KR) 2004-85805

(51) Int. Cl. G10L 21/02

(52) U.S. Cl. 704/226

(57) ABSTRACT

A method and apparatus to eliminate noise from a plurality of channel audio signals in which surrounding noise is mixed. The method includes detecting an existence of noise in frame units by averaging a plurality of channel input signals and estimating a noise signal of a noise-detected frame, and subtracting the estimated noise signal from each of the plurality of channel input signals.

### CROSS-REFERENCE TO RELATED APPLICATIONS

This application claims priority from Korean Patent Application No. 2004-85805, filed on Oct. 26, 2004, in the Korean Intellectual Property Office, the disclosure of which is incorporated herein in its entirety by reference.

### BACKGROUND OF THE INVENTION

1. Field of the Invention

The present general inventive concept relates to audio recorders and playback devices, and more particularly, to a method and apparatus to eliminate noise from multi-channel audio signals in which a surrounding noise is mixed.

2. Description of the Related Art

When recording a motion picture using a camcorder, noise is typically generated by a zoom motor and/or a drum motor. This noise is recorded together with an audio signal through a microphone. Thus, the recorded noise decreases sound quality when the audio signal is reproduced.

Therefore, a noise elimination technology for eliminating noise generated in the surrounding environment is necessary. In general, a spectral noise elimination apparatus uses a spectral subtraction method in order to eliminate background noise. This method will now be described with reference to FIG. 1. FIG. 1 illustrates a conventional noise elimination apparatus.

A single channel analog signal input through a microphone (not shown) is converted to a digital signal. The converted digital signal is divided into frames in a time domain. The framed signal is windowed in order to reduce information cutoff and distortion between frames. A fast Fourier transformer (FFT) 110 transforms the windowed signal into frequency spectrum information by performing a fast-Fourier transform on the windowed signal.

The frequency spectrum information includes magnitude spectrum information and phase spectrum information. Here, the magnitude spectrum information is used for spectral subtraction, and the phase spectrum information is used for inverse fast-Fourier-transformation.

A noise detector 120 determines whether a current frame signal, which is fast-Fourier-transformed by the FFT 110, is a noise-only frame signal (i.e., only includes the background noise) or a frame signal in which noise and audio signals are mixed.

A noise spectrum unit 130 stores a spectral pattern of the noise-only frame signal if the noise detector 120 determines that the current frame signal is a noise-only frame signal.

A spectral subtractor 140 subtracts an estimated noise spectrum, which is based on the stored spectral pattern of the noise-only frame, from a magnitude spectrum in which audio and noise signals are mixed.

Under normal noise characteristics, the estimated noise spectrum closely approximates an actual noise component spectrum. Therefore, an output magnitude spectrum obtained by performing the spectral subtraction closely approximates an audio-only magnitude spectrum from which the noise signal is eliminated.

An inverse FFT (IFFT) 150 then restores an audio spectrum including the output magnitude spectrum information and the phase spectrum information into an original signal in the time domain by performing an inverse fast-Fourier transform on the audio spectrum.

In conventional noise elimination technology and, in particular, the conventional noise elimination apparatus of FIG. 1, the elements which require the most computing are the FFT 110, which transforms a signal in the time domain into a signal in a frequency domain, and the IFFT 150, which restores a signal in the frequency domain into a signal in the time domain. The amount of computing of the FFT 110 and the IFFT 150 can be used to approximate a total amount of computing.

The conventional noise elimination apparatus can eliminate noise from a single channel audio signal. Therefore, a conventional noise elimination apparatus for eliminating noise from multi-channel audio signals must use a plurality of single channel conventional noise elimination apparatuses. Accordingly, in a conventional multi-channel noise elimination system, the amount of FFTs and IFFTs increases according to the number of channels to be processed, thereby increasing the amount of computing.

### SUMMARY OF THE INVENTION

The present general inventive concept provides a method of eliminating noise from multi-channel audio signals in which an amount of computation used to transform signals between the time and frequency domains is maintained at a constant level regardless of an increase in a number of channels being processed. A noise processing unit is shared with respect to the multi-channel audio signals in which surrounding noise is mixed.

The present general inventive concept also provides a noise elimination apparatus to perform the method of eliminating noise from multi-channel audio signals.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of eliminating noise from a plurality of channel audio signals, the method comprising: detecting an existence of noise in one or more frame units by averaging a plurality of channel input signals and estimating a noise signal of a noise-detected frame, and subtracting the estimated noise signal from each of the plurality of channel input signals.

The foregoing and/or other aspects and advantages of the present general inventive concept may also be achieved by providing a noise elimination apparatus to eliminate noise from a plurality of channel audio signals comprising: a noise processing unit to detect an existence of noise in one or more frame units by averaging a plurality of channel input signals and to estimate a noise signal of a noise-detected frame, and a plurality of subtractors to subtract the estimated noise signal from each of the plurality of channel input signals.

The noise processing unit may comprise an adder to add the plurality of channel input signals, an averaging unit to average levels of the added plurality of channel input signals, a fast Fourier transform (FFT) unit to transform a signal output from the averaging unit into a frequency spectrum in the one or more frame units, a noise frame detector to determine the existence of noise in the one or more frame units with respect to the frequency spectrum, a noise spectrum unit to estimate and store a noise only spectrum of a current frame when a current frame is determined as a frame containing only noise content, and an inverse fast Fourier transform (IFFT) unit to transform the noise only spectrum into the estimated noise signal in a time domain by performing an inverse-fast-Fourier transform of the noise only spectrum.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a conventional apparatus for eliminating noise from an audio signal;

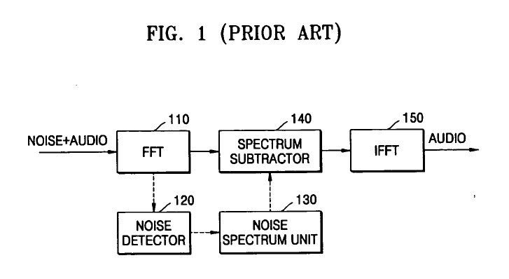

FIG. 2 is a block diagram illustrating a noise elimination apparatus to eliminate noise from a multi-channel audio signal according to an embodiment of the present general inventive concept; and

FIGS. 3A through 3H are waveform diagrams illustrating a method of eliminating noise from the multi-channel audio signal according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

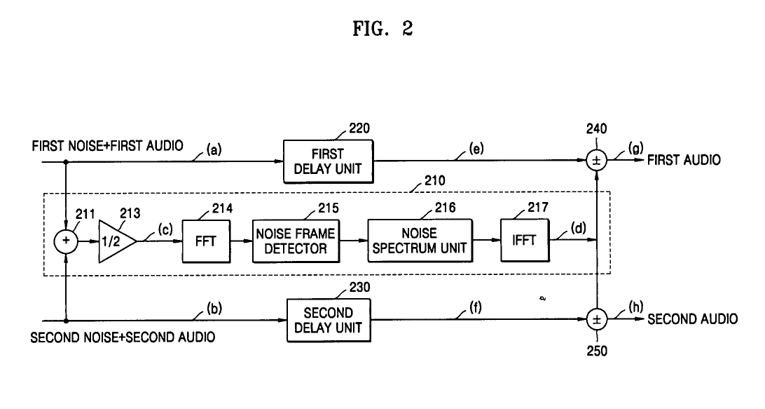

FIG. 2 is a block diagram illustrating a noise elimination apparatus to eliminate noise from a multi-channel audio signal according to an embodiment of the present general inventive concept.

Referring to FIG. 2, the noise elimination apparatus includes a first delay unit 220, a second delay unit 230, a noise processing unit 210, a first subtractor 240, and a second subtractor 250. The noise processing unit 210 includes an adder 211, an averaging unit 213, a fast Fourier transform (FFT) unit 214, a noise frame detector 215, a noise spectrum unit 216, and an inverse FFT (IFFT) unit 217.

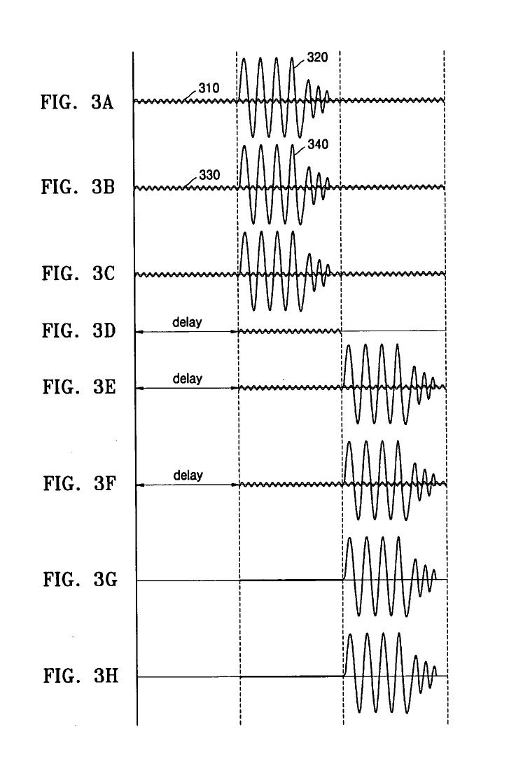

The noise elimination apparatus illustrated in FIG. 2 will now be described with reference to waveform diagrams illustrated in FIG. 3.

Multi-channel signals are input. Here, it is assumed that a noise content and an audio content are mixed in each channel. As illustrated in FIG. 3A, a first noise signal 310 and a first audio signal 320 are mixed in a first channel signal. Similarly, as illustrated in FIG. 3B, a second noise signal 330 and a second audio signal 340 are mixed in a second channel signal.

The noise processing unit 210 detects an existence of noise in frame units by averaging signal levels of a first channel and a second channel, and estimates a noise signal of a noise-detected frame.

The noise processing unit 210 will now be described in detail.

The adder 211 adds the first channel signal (a) illustrated in FIG. 3A and the second channel signal (b) illustrated in FIG. 3B.

The averaging unit 213 averages the levels of the signals added by the adder 211.

The FFT unit 214 divides the averaged signal (c), which is illustrated in FIG. 3C, into a plurality of frame units, windows the divided signals in every frame, and transforms the signals divided into frame units into frequency spectrum information by performing a fast-Fourier transform of the divided signals. The windowing may be performed using a Hamming window method or a Hanning window method.

The noise frame detector 215 determines whether a current frame signal is a noise-only frame signal (i.e., only includes a noise signal) or a frame signal in which noise and audio signals are mixed. A plurality of methods can be used to determine whether the current frame signal is a noise-only frame signal. For example, if an energy of the current frame signal is less than a threshold, the current frame signal may be determined to be a noise-only frame signal.

The noise spectrum unit 216 stores a noise spectrum pattern of the current frame signal when the current frame signal is determined to be a noise-only frame signal by the noise frame detector 215. In general, the noise spectrum pattern of a voice region is estimated by averaging a magnitude spectrum of a noise region.

The IFFT unit 217 restores the noise spectrum pattern stored in the noise spectrum unit 216 into an original noise signal (d) in the time domain as illustrated in FIG. 3D by performing an inverse-fast-Fourier transform on the stored noise spectrum pattern. Additionally, when the noise frame detector 215 determines that the current frame signal is not the noise only frame, the noise spectrum unit 216 outputs a noise spectrum pattern from a previous signal frame for processing. In other words, the noise frame detector 215 updates the noise spectrum pattern that is used to estimate the first and second noise signals 310 and 330 whenever a noise-only frame is detected. The stored noise spectrum pattern is used for processing until another noise-only frame is detected, at which point, the stored noise spectrum pattern is updated.

The first delay unit 220 delays the first channel signal (a) illustrated in FIG. 3A, in which the first noise signal 310 and the first audio signal 320 are mixed, while the first channel signal (a) is processed by the noise processing unit 210 as illustrated in FIG. 3E. That is, the first delay unit 220 delays the first channel signal (a) for a predetermined time in order to synchronize the first channel signal (a) with the noise signal, which is delayed by the FFT unit 214 and the IFFT unit 217 included in the noise processing unit 210. In particular, the noise signal output by the IFFT unit 217 is in sync with the first channel signal output by the first delay unit 220.

The second delay unit 230 delays the second channel signal (b) illustrated in FIG. 3B, in which the second noise signal 330 and the second audio signal 340 are mixed, while the second channel signal (b) is processed by the noise processing unit 210 as illustrated in FIG. 3F. That is, the second delay unit 230 delays the second channel signal (b) for a predetermined time in order to synchronize the second channel (b) signal with the noise signal, which is delayed by the FFT unit 214 and the IFFT unit 217 included in the noise processing unit 210. In particular, the noise signal (d) output by the IFFT unit 217 is in sync with the second channel signal output by the second delay unit 230.

The first subtractor 240 subtracts the noise signal (d) output from the IFFT unit 217 from the delayed first channel signal (e) in which the first noise signal 310 and the first audio signal 320 are mixed. The subtracted first channel signal (g) is illustrated in FIG. 3G. Referring to FIG. 3G, the first subtractor 240 outputs the first audio signal 320 obtained by eliminating the first noise signal 310 from the delayed first channel signal (e).

The second subtractor 250 subtracts the noise signal (d) output from the IFFT unit 217 from the delayed second channel signal (f) in which the second noise signal 330 and the second audio signal 340 are mixed. The subtracted second channel signal (h) is illustrated in FIG. 3H. Referring to FIG. 3H, the second subtractor 250 outputs the second audio signal 340 obtained by eliminating the second noise signal 330 from the delayed second channel signal (f).

Accordingly, by sharing the noise processing unit 210 among multiple audio channels, the amount of FFT and IFFT computation can be maintained constant regardless of the number of channels in the system. The multiple audio channels share the noise processing unit 210 by determining an estimated noise spectrum from an average signal of the multiple audio channels. Since background noise does not tend to vary among the multiple audio channels (i.e., it is recorded equally in signals of the multiple audio channels), noise in each of the multiple audio channels can be accurately approximated using the noise spectrum estimated from the average signal of the multiple audio signals.

The present general inventive concept may be embodied in a computer by running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present general inventive concept may be embodied as a computer-readable medium having a computer-readable program code to cause a number of computer systems connected via a network to effect distributed processing.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of eliminating noise from a plurality of channel audio signals, the method comprising:
detecting an existence of noise in one or more frame units by averaging a plurality of channel input signals and estimating a noise signal of a noise-detected frame; and
subtracting the estimated noise signal from each of the plurality of channel input signals.

2. The method of claim 1, wherein the detecting of the existence of noise and the estimating of the noise signal comprises:
adding the plurality of channel input signals and averaging the added plurality of channel input signals;
transforming the averaged plurality of channel input signals into a frequency spectrum;
determining the existence of noise with respect to the frequency spectrum;
storing a noise-only spectrum when the frequency spectrum is determined to include only noise content; and
transforming the noise only spectrum into the estimated noise signal in a time domain.

3. The method of claim 1, wherein the detecting of the existence of noise comprises determining whether a current frame signal is a noise-only frame signal according to a determination of whether an energy of the current frame signal is less than a predetermined threshold.

4. The method of claim 1, wherein the subtracting of the estimated noise signal comprises:
delaying the plurality of channel input signals while the input signals are noise-processed, the existence of noise is detected, and the noise signal is estimated; and
subtracting the estimated noise signal from the delayed plurality of channel input signals.

5. A method of eliminating noise from at least two channels, the method comprising:
receiving at least a first channel signal and a second channel signal;
combining the first channel signal and the second channel signal;
estimating a noise signal according to the combined signal; and
subtracting the estimated noise signal from each of the first and second channel signals.

6. The method of claim 5, wherein the combining of the first and second channel signals comprises averaging signal levels of the first and second channel signals.

7. The method of claim 5, wherein the estimating of the noise signal comprises storing spectrum information of a frame of the combined signal that is determined to contain only noise as the estimated noise signal.

8. The method of claim 7, wherein the storing of the spectrum information comprises updating the estimated noise signal when a subsequent frame is determined to contain only noise.

9. The method of claim 5, wherein the estimating of the noise signal comprises:
determining whether a current frame of the combined signal is a frame containing only noise content or whether the current frame of the combined signal is a frame containing audio and noise content;
storing spectrum information of the current frame of the combined signal when the current frame is determined to contain only noise content as the estimated noise signal; and
retrieving previously stored spectrum information of a previous frame of the combined signal that contains only noise content as the estimated noise signal when the current frame is determined to contain audio and noise content.

10. The method of claim 5, wherein the subtracting of the estimated noise signal comprises:
delaying each of the first and second channel signals while the noise signal is estimated such that the first and second channel signals are synchronized with the estimated noise signal; and
subtracting the estimated noise signal from each of the delayed first and second channel signals.

11. The method of claim 5, wherein the estimating of the noise signal comprises:
converting the combined signal having one or more frames from a time domain to a frequency domain;
processing noise in the combined signal to determine frequency spectrum information of the estimated noise signal; and
converting the frequency spectrum information of the estimated noise signal back to the time domain to obtain the estimated noise signal.

12. A noise elimination apparatus to eliminate noise from a plurality of channel audio signals, the apparatus comprising:
a noise processing unit to detect an existence of noise in one or more frame units by averaging a plurality of channel input signals and to estimate a noise signal of a noise-detected frame; and
a plurality of subtractors to subtract the estimated noise signal from each of the plurality of channel input signals.

13. The apparatus of claim 12, wherein the noise processing unit comprises:
an adder to add the plurality of channel input signals;
an averaging unit to average levels of the added plurality of channel input signals;
a fast Fourier transform (FFT) unit to transform a signal output from the averaging unit into a frequency spectrum in the one or more frame units;
a noise frame detector to determine the existence of noise in the one or more frame units with respect to the frequency spectrum;
a noise spectrum unit to estimate and store a noise only spectrum of a current frame when a current frame is determined to be a frame containing only noise content; and
an inverse FFT (IFFT) unit to transform the noise only spectrum into the estimated noise signal in a time domain by performing an inverse-fast-Fourier transform of the noise only spectrum.

14. The apparatus of claim 12, further comprising:
a plurality of delay units to delay each of the input signals of the plurality of channel input signals in which noise and audio signals are mixed while the plurality of channel input signals are processed by the noise processing unit.

15. An apparatus to eliminate noise from at least two channels, comprising:
a combination unit to combine at least a first channel signal and a second channel signal into a combined signal;
a noise estimation unit to estimate a noise signal according to the combined signal; and
a subtraction unit to subtract the estimated noise signal from each of the first and second channel signals.

16. The apparatus of claim 15, wherein the combination unit comprises an averaging unit to average signal levels of the first and second channel signals.

17. The apparatus of claim 15, wherein the noise estimation unit comprises a noise spectrum unit to store spectrum information of a frame of the combined signal that is determined to contain only noise as the estimated noise signal.

18. The apparatus of claim 17, wherein the noise spectrum unit updates the estimated noise signal when a subsequent frame of the combined signal is determined to contain only noise.

19. The apparatus of claim 15, wherein the noise estimation unit comprises:
a noise frame detector to determine whether a current frame of the combined signal is a frame containing only noise content or whether the current frame of the combined signal is a frame containing audio and noise content; and
a noise spectrum unit to store spectrum information of the current frame of the combined signal when the current frame is determined to contain only noise content as the estimated noise signal, and to retrieve previously stored spectrum information of a previous frame of the combined signal that contains only noise content as the estimated noise signal when the current frame is determined to contain audio and noise content.

20. The apparatus of claim 15, wherein the subtraction unit comprises:
first and second delay units to delay the first and second channel signals while the noise estimation unit estimates the noise signal such that the first and second channel signals are synchronized with the estimated noise signal; and
first and second subtractors to subtract the estimated noise signal from each of the delayed first and second channel signals.

21. The apparatus of claim 15, wherein the noise estimation unit comprises:
a frequency conversion unit to convert the combined signal having a plurality of frames from a time domain to a frequency domain;
a noise processor to process noise in the combined signal to determine spectrum information of the estimated noise signal; and
a time conversion unit to convert the frequency spectrum information of the estimated noise signal back to the time domain to obtain the estimated noise signal.

22. An apparatus to eliminate noise from a plurality of channel signals, comprising:
a shared noise processor to receive the plurality of channel signals and to process noise for the plurality of channel signals;
a plurality of bypass signal paths on which the plurality of channel signals are carried to bypass the shared noise processor; and
a subtraction unit to subtract the noise processed by the shared noise processor from the plurality of channel signals that bypass the shared noise processor.

23. The apparatus of claim 22, wherein the shared noise processor comprises a single frequency domain conversion unit and a single time domain conversion unit.

24. A computer readable medium containing executable code to eliminate noise from at least two channels, the medium comprising:
a first executable code to receive at least a first channel signal and a second channel signal;
a second executable code to combine the first channel signal and the second channel signal;
a third executable code to estimate a noise signal according to the combined signal; and
a fourth executable code to subtract the estimated noise signal from each of the first and second channel signals.
